(19) United States
(12) Patent Application Publication
(10) Pub. No.: US 2015/0244243 A1
(43) Pub. Date: Aug. 27, 2015

(54) CONNECTION DEVICE FOR A ROTARY ELECTRIC MACHINE AND USE OF SUCH A CONNECTION DEVICE IN AN ELECTRIC SUPERCHARGER

(71) Applicants: Fabien Guerin, Chatillon (FR); Philippe Baudesson, La Boissiere (FR); Patrick Lebrasseur, Montagny-En-Vexin (FR); Amine Bencheikh, Epinay Sur Seine (FR); Amaury Rouet, Paris (FR)

(72) Inventors: Fabien Guerin, Chatillon (FR); Philippe Baudesson, La Boissiere (FR); Patrick Lebrasseur, Montagny-En-Vexin (FR); Amine Bencheikh, Epinay Sur Seine (FR); Amaury Rouet, Paris (FR)

(73) Assignee: VALEO EQUIPEMENTS ELECTRIQUES MOTEUR, Creteil Cedex (FR)

(21) Appl. No.: 14/631,636

(22) Filed: Feb. 25, 2015

(30) Foreign Application Priority Data
Feb. 25, 2014 (FR) 1451494

(51) Int. Cl. H02K 11/00

(52) U.S. Cl. CPC H02K 11/0094

(57) ABSTRACT

A connection device is provided for a rotary electric machine of the type supplied with power by a plurality of first pins arranged on a bearing of an axis of the machine at predetermined angular intervals around the axis at a first predetermined distance. The connection device includes a plurality of second pins that are arranged around the axis at a second predetermined distance, which is greater than the first predetermined distance, and that are electrically connected to a plurality of first terminals able to be connected to the first pins. The connection device also includes a main part made of plastics material with a plurality of overmoulded metal bars connecting the second pins and the first terminals.

### TECHNICAL FIELD OF THE INVENTION

The present invention relates to a connection device for a rotary electric machine for applications in the automotive field, in particular for an electric motor of an electric supercharger.

The invention also relates to an electric supercharger comprising this connection device.

### TECHNICAL BACKGROUND OF THE INVENTION

Ecological considerations and in particular the fight against global warming by reducing CO₂ emissions have led equipment manufacturers to offer car manufacturers electric superchargers that improve the dynamic response of small, low-speed internal combustion engines.

In contrast to conventional superchargers driven by the exhaust gases, the electric supercharger, that is to say driven by an electric motor, has an instantaneous response time and improves the engine torque at low speed and under acceleration.

This system makes it possible to significantly reduce the size of heat engines and consequently to reduce fuel consumption.

In the case of a diesel engine the latency period of a gas supercharger is also responsible for the emission of particles when, in a low-speed acceleration phase, the injection system tries to provide the requested power by injecting a surplus of fuel.

In order to overcome this disadvantage the company VALEO SYSTEMES DE CONTROLE MOTEUR proposes in its international patent application WO 2013/045821 the implementation of an electric supercharger in order to assist the gas turbocharger at the moment at which the accelerator pedal is pressed.

However, in some embodiments of such a system it may be difficult to connect the electric motor phase inputs to the electric power supply due to the fact that these inputs are usually close to the axis and also to tightness constraints between the turbine part and the electric part, as indicated in international patent application WO 2005/024202.

Within the scope of the development of electric superchargers, the inventive entity was faced with a problem of this type for connection of the phase inputs to a power circuit board of a size much greater than the diameter of the electric motor.

### General Description of the Invention

The object of the present invention is thus to provide a solution to this problem.

The invention specifically relates to a connection device for a rotary electric machine of the type supplied with power by means of a plurality of first pins arranged on a bearing of an axis of this machine at predetermined angular intervals around this axis and at a first predetermined distance.

This connection device is noteworthy in that it comprises a plurality of second pins that are also arranged around this axis at a second predetermined distance, which is greater than the first predetermined distance, and that are electrically connected to a plurality of first terminals capable of being connected to the first pins.

The connection device advantageously comprises a main part made of plastics material with a plurality of overmoulded metal bars connecting the second pins and the first terminals.

This connection device preferably also comprises first sealing means able to cooperate with the bearing of the electric machine and second sealing means cooperating with a cover.

These first sealing means advantageously comprise a first crown cooperating with a first circumferential groove in the main part. The second sealing means are also formed advantageously of a second crown cooperating with a second circumferential groove in the main part and a circumferential bearing surface of the cover.

The second pins are preferably distributed in twos around the axis of the rotary electric machine.

According to an embodiment, the second pins are distributed regularly around the axis of the rotary electric machine.

According to an embodiment, the metal bars extend substantially radially from respective first terminals.

According to an embodiment, said cover is configured to cover in a sealed manner a central area of the connection device surrounding the axis, said area comprising the first terminals. Preferably, the cover is configured to cover said area in a sealed manner owing to the second sealing means. Particularly, said area extends from the axis of the machine over a distance comprised between the first distance and the second distance.

According to an embodiment, said first sealing means comprise a first crown cooperating with a first circumferential groove in said main part, and said second sealing means comprise a second crown cooperating with a second circumferential groove in said main part and a circumferential bearing surface of said cover. Preferably, the first crown cooperates with a first circumferential groove in said main part and said bearing, particularly a groove in said bearing.

The invention also relates to a rotary electric machine of the type supplied with power by means of a plurality of first pins arranged on a bearing of an axis of this machine at predetermined angular intervals around said axis at a first predetermined distance.

This rotary electric machine is noteworthy in that it comprises a connection device having the features described above, a plurality of first terminals of the connection device being welded to the first pins.

This rotary electric machine preferably comprises at least one position sensor arranged on the connection device.

The rotary electric machine according to the invention highly advantageously comprises a power circuit board comprising a plurality of second terminals that are arranged around the axis at said second predetermined distance, which is greater than the first predetermined distance, and that are electrically connected to the first pins by means of the connection device.

According to an embodiment, the position sensor is arranged at least partially in a housing in the cover of the connection device. Preferably, the position sensor is arranged so that to extend proximate to a rotation rod of the electric machine, said rotation rod extending along the axis of the electric machine. Preferably, at least a portion of the position sensor extends opposite the rotation rod so that to detect an angular position of the electric machine owing to, for example, a magnetic effect.

According to an embodiment, the second terminals are positioned at a periphery of the power circuit board. Preferably, the power circuit board is over the connection device, particularly over the central area of the connection device.

The invention also relates to a motor vehicle supercharger intended for a heat engine supercharger system noteworthy in that said supercharger is driven by the rotary electric machine specified above.

These essential specifications will have made clear to a person skilled in the art the advantages offered by the connection device according to the invention and also by the rotary electric machine and the electric supercharger used thereby compared with the earlier prior art.

The detailed specifications of the invention are provided in the following description in combination with the accompanying drawings. It should be noted that these drawings are intended merely to illustrate the text of the description and in no way limit the scope of the invention.

### BRIEF DESCRIPTION OF THE DRAWINGS

FIG. 1 is a view from above of an electric part of a supercharger known from the prior art showing a power circuit board of a type covered by the invention.

FIGS. 2a and 2b are, respectively, a perspective view of the main part of the connection device according to the invention and a perspective view of the device.

FIGS. 3a and 3b are, respectively, an exploded view of the connection device according to the invention and a radial half-section thereof.

FIG. 4 is a partial exploded view of a rotary electric machine according to the invention.

FIG. 5 is a view from above of an electric part of an electric supercharger according to the invention showing the power circuit board.

FIG. 6 is an exploded view of an electric supercharger according to the invention.

### DESCRIPTION OF THE PREFERRED EMBODIMENT OF THE INVENTION

Within the scope of the development of an electric supercharger the inventors would have ensured an electrical connection between the phase inputs 1 of the electric machine 2 and connection parts 3 of a power circuit board 4.

A stator in a specific exemplary embodiment of this machine 2 has a first diameter of substantially 40 mm and the power circuit board 4 has a second diameter substantially of 110 mm.

As a result, first pins 1, corresponding to these phase inputs, which are arranged on a bearing of the machine 2 at predetermined angular intervals around the axis, are at a first predetermined distance D1 from the axis equal to at most 20 mm.

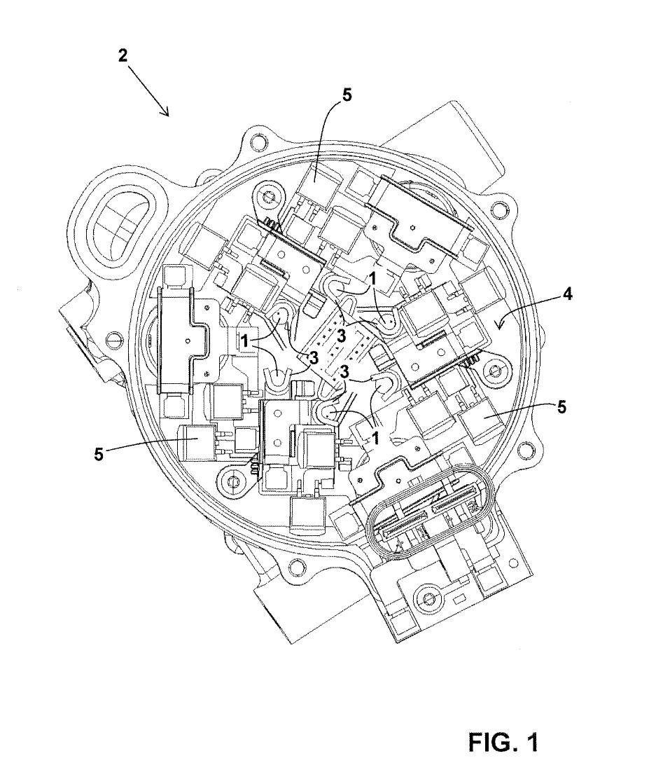

As shown clearly in FIG. 1, these first pins 1 then pass into the connection parts 3 in the middle of the power circuit board 4.

The presence of these connection parts 3 at this location limits the possibilities for placement of electronic components 5 and routing thereof, resulting in an impossibility of such placement.

In addition, the electronic components 5 are not protected with respect to the turbine part of the supercharger because there is no seal between the turbine part and the electric part 2.

The invention is characterized by a connection device 6 comprising a main part 7 made of plastic with overmoulded metal bars 8 placed between the power circuit board 4 and a bearing of the electric machine 2 on which this board 4 is mounted. The function of said connection device is as follows:
to ensure the seal between the power circuit board 4 and the bearing;
to ensure the electrical connections between the circuit board 4 and the phase inputs 1;
to free routing space of the power circuit board 4 by moving the connection parts 3 for connection to the phases 1 back to the periphery of the circuit board 4;
to ensure a suitable assembly process (electronic components 5 protected from particles generated by welding of the first pins 1 to the power circuit board 4);
to ensure the positioning of the seal of a position sensor.

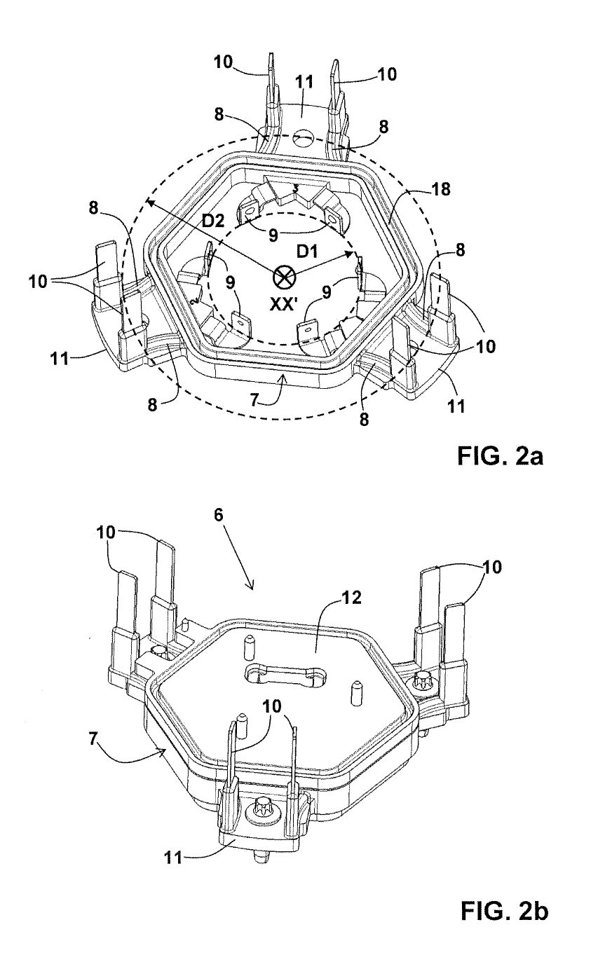

As shown clearly in FIG. 2a the main part 7 of the connection device 6 according to the invention comprises a plurality of first terminals 9 connected by the metal bars 8 to a plurality of second pins 10.

The first terminals 9 are arranged substantially at the first predetermined distance D1 from the axis XX′ so as to be able to be welded to the first pins 1 of the phase inputs.

The second pins 10, intended to be welded to the power circuit board 4, are arranged around the axis XX′ at a second predetermined distance D2, which is greater than the first predetermined distance D1, of at most 55 mm corresponding to the second diameter of the power circuit board 4 in this particular exemplary embodiment.

In this particular embodiment the main part 7 is substantially hexagonal. A circular shape or other shapes can also be selected in other embodiments of the invention.

The second pins 10, which extend parallel to the axis XX′ of the machine 2 in radial planes, are grouped in twos and are distributed over three supports 11 carried by three sides of the hexagon and extending in the plane thereof.

FIG. 2b shows the complete connection device 6 according to the invention.

In order to isolate the power circuit board 4 from the bearing of the electric machine 2, the main part 7 is provided with a cover 12.

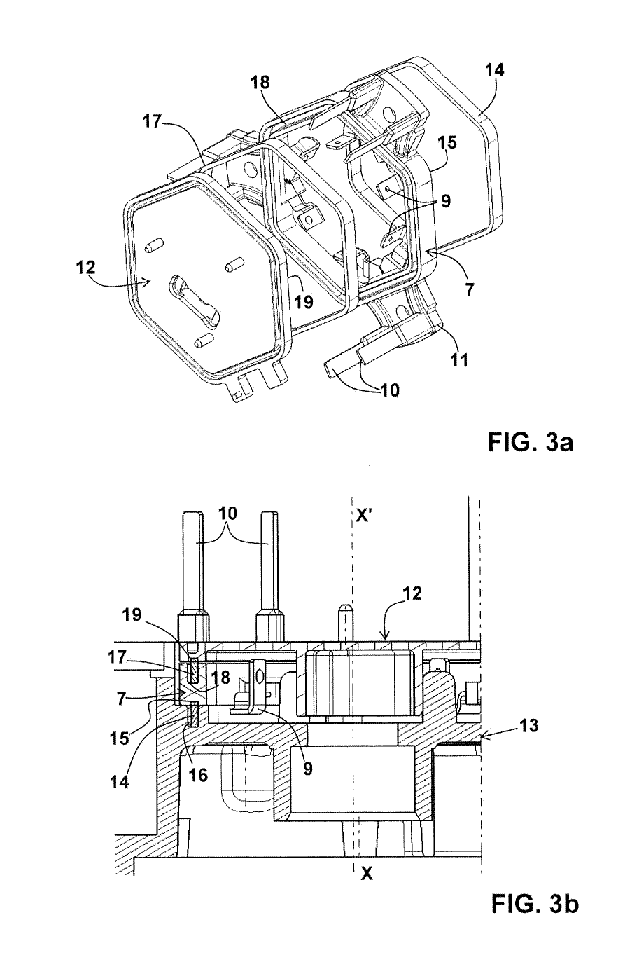

The exploded view of FIG. 3a and the radial section of FIG. 3b show how the seal between the main part 7 and the bearing 13 is obtained by means of a first hexagonal crown 14 of rectangular section cooperating with a first circumferential groove 15 in the main part 7 on the one hand and with a slot 16 in the bearing 13 on the other hand.

In the same way, the seal between the main part 7 and the cover 12 is obtained by means of a second hexagonal crown 17 similar to the first and cooperating with a second circumferential groove 18 in the main part 7 on the one hand and with a circumferential bearing surface 19 of the cover 12 on the other hand.

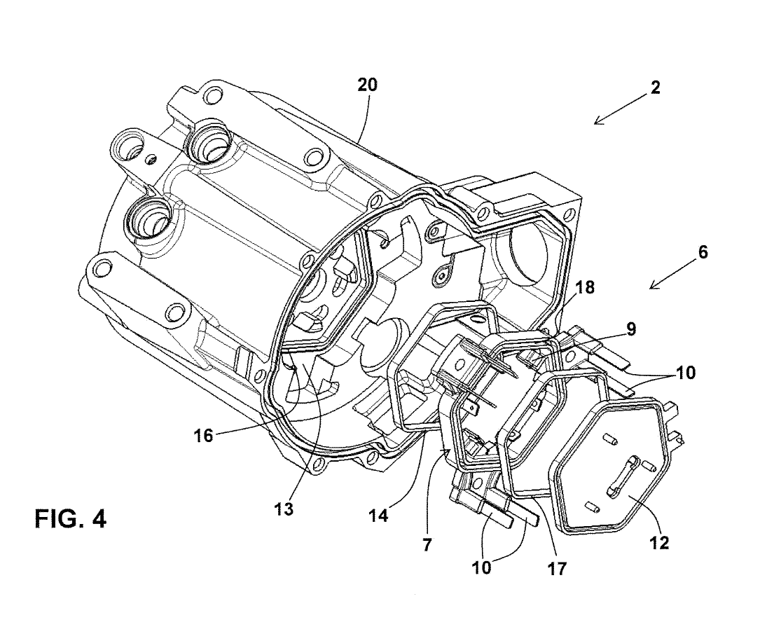

The partial exploded view of FIG. 4 shows the arrangement of the connection device 6 according to the invention within a casing 20 of the electric machine 2.

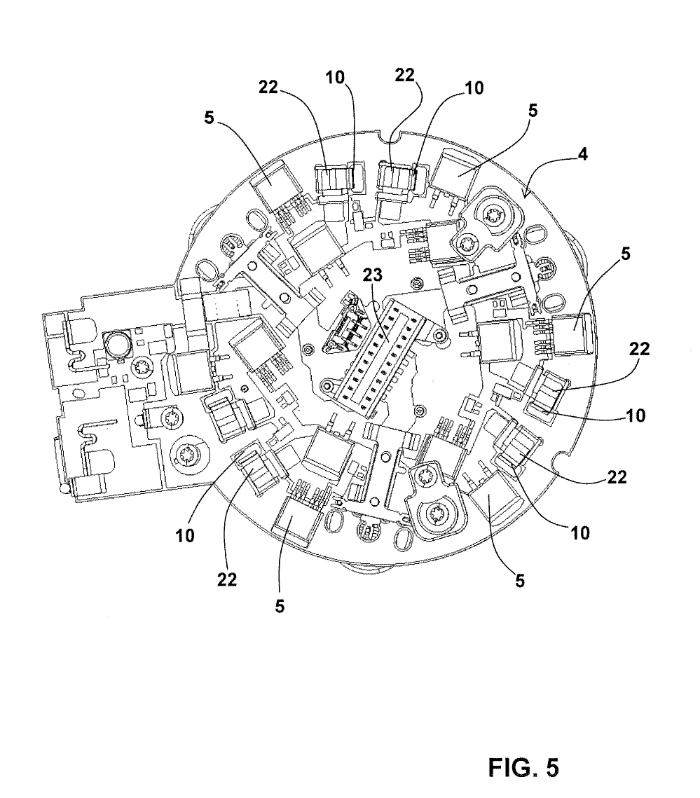

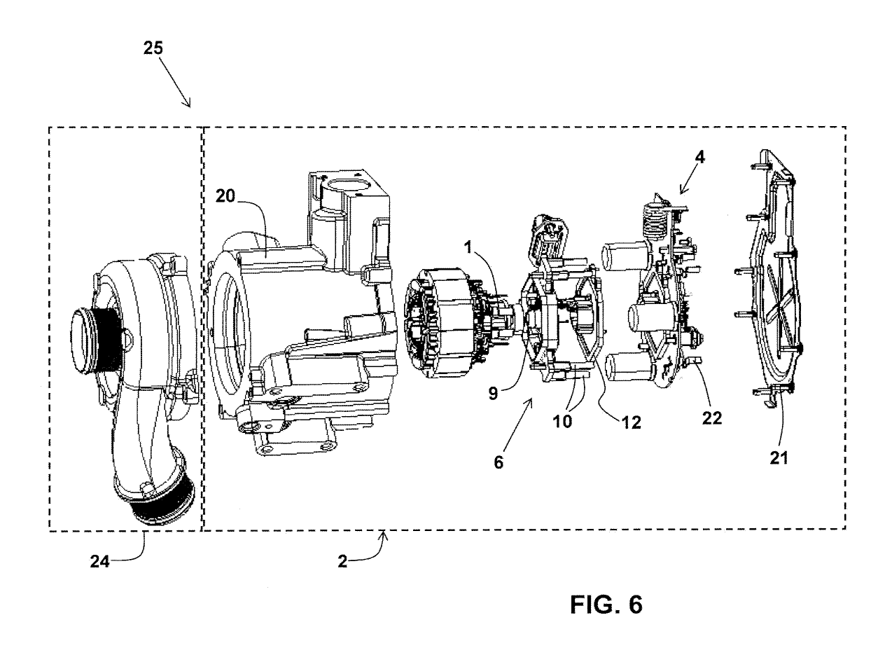

The power circuit board 4, shown in FIG. 5, is also shown inside the casing 20 on the cover 12 of the connection device 6 as shown by the exploded view of the electric supercharger according to the invention of FIG. 6.

The casing 20 is closed by a lid 21.

The principle of the invention is based on the use of a metal bar 8 that enables a first weld to each phase 1 of the machine 2, then in a second step a second weld for connection to each of the second terminals 22 of each phase 1 of the power circuit board 4.

This process in two steps enables:
in a first step, the placement in the machine 2 of the main part 7 made of overmoulded plastic with a first seal 14, 15, 16 over the periphery and access to the motor phases 1 for a first weld;
in a second step, the obstruction by the cover 12, or resin, of the part accessible for the first weld in order to ensure a second seal 17, 18, 19;
separate welding, in a zone that can be kept clean, of the second pins 10 of the main part 7 with the second terminals 22 of the power circuit board 4.

The second terminals 22 are surface-mounted devices (SMDs) that occupy a reduced space on the insulated metallized substrate (IMS) of the power circuit board 4.

The space freed in the middle of the board 4 by the electronic components 5, in particular power semiconductors of the MOSFET type, comprises a signal interconnector 23.

The rotary electric machine 2 formed in this way is coupled to the turbine part 24 in order to form a compact electric supercharger 25 of which the integrated power circuit board 4 is easily assembled and immune to polluting particles.

Of course, the invention is not limited to the single preferred embodiment described above, in particular the number of phases of the rotary electric machine 2 is merely an example.

The overall hexagonal-based prismatic form of the connection device 6 according to the invention is also merely an example of a preferred embodiment.

In a variant the main part 7 is circular and the metal bars 8 overmoulded in arms extending radially are connected to second pins 22 extending parallel to the axis XX′ in tangential planes.

In a further variant the first and second crowns 14, 17 are advantageously replaced by O-rings, the first circumferential groove 15 of the main part 7 and the circumferential bearing surface 19 of the cover 12 being omitted.

In an embodiment, a position sensor is positioned at least partially in a housing in the cover 12. This housing can be seen in FIG. 2b for instance. The position sensor can be overmolded by the material of the cover 12.

The scope of the invention therefore also includes embodiments other than those described in detail above, provided these fall within the scope specified by the following claims.

1. A connection device for a rotary electric machine,
the connection device being supplied with power by a plurality of first pins arranged on a bearing of an axis of said machine at predetermined angular intervals around said axis at a first predetermined distance,
said connection device comprising a plurality of second pins that are arranged around said axis at a second predetermined distance, which is greater than said first predetermined distance, and that are electrically connected to a plurality of first terminals able to be connected to said first pins.

2. The connection device for a rotary electric machine according to claim 1, further comprising a main part made of plastics material with a plurality of overmoulded metal bars connecting said second pins and said first terminals.

3. The connection device for a rotary electric machine according to claim 2, wherein the metal bars extend substantially radially from respective first terminals.

4. The connection device for a rotary electric machine according to claim 1, further comprising first sealing means able to cooperate with said bearing and second sealing means cooperating with a cover.

5. The connection device for a rotary electric machine according to claim 4, wherein said cover is configured to cover in a sealed manner a central area of the connection device surrounding the axis, said area comprising the first terminals.

6. The connection device for a rotary electric machine according to claim 4, wherein said first sealing means comprise a first crown cooperating with a first circumferential groove in said main part, and said second sealing means comprise a second crown cooperating with a second circumferential groove in said main part and a circumferential bearing surface of said cover.

7. The connection device for a rotary electric machine according to claim 1 said second pins are distributed in twos around said axis.

8. A rotary electric machine supplied with power by a plurality of first pins arranged on a bearing of an axis of said machine at predetermined angular intervals around said axis at a first predetermined distance, said rotary electric machine comprising a connection device according to claim 1, a plurality of first terminals of said connection device being welded to said first pins.

9. The rotary electric machine according to claim 8, wherein said rotary electric machine comprises at least one position sensor arranged on said connection device.

10. The rotary electric machine according to claim 9, wherein the connection device further comprises first sealing means able to cooperate with said bearing and second sealing means cooperating with a cover is and the position sensor is arranged at least partially in a housing in the cover.

11. The rotary electric machine according to claim 8, further comprising a power circuit board comprising a plurality of second terminals that are arranged around said axis at said second predetermined distance, which is greater than said first predetermined distance, and that are electrically connected to said first pins by said connection device.

12. The rotary electric machine according to claim 11, wherein the second terminals are positioned at a periphery of the power circuit board.

13. The motor vehicle supercharger intended for a supercharger system of a heat engine, wherein said supercharger is driven by a rotary electric machine according to claim 8.
